(19) United States
(12) Patent Application Publication
(10) Pub. No.: US 2026/0161016 A1
(43) Pub. Date: Jun. 11, 2026

(54) Eyeglass Attachment Device

(71) Applicant: Ronald Laporte, Bronx, NY (US)

(72) Inventor: Ronald Laporte, Bronx, NY (US)

(21) Appl. No.: 19/243,448

(22) Filed: Jun. 19, 2025

Related U.S. Application Data
(60) Provisional application No. 63/728,192, filed on Dec. 5, 2024.

(51) Int. Cl. G02C 3/00; G02C 5/20

(52) U.S. Cl. CPC G02C 3/003; G02C 5/20

(57) ABSTRACT

An eyeglasses attachment device is disclosed, which is designed to address common issues associated with prolonged eyewear use, such as eye strain, nasal congestion, and skin indentations caused by constant pressure from glasses. The eyeglasses attachment device comprises an internal gear structure component with a cross-member component and a toothed, adjustable central post component featuring a cradle component to hold the arms of the eyewear securely. Further, the device has a latex coating that allows for comfortable, secure contact with the skin, while its adjustable positioning mechanism ensures optimal distance for vision comfort. Additionally, the bottom portion of the device can be moistened so the moist side faces the skin and allows gravity to redefine how the glasses are worn.

### CROSS-REFERENCE TO RELATED APPLICATION

The present application claims priority to, and the benefit of, U.S. Provisional Application No. 63/728,192, which was filed on Dec. 5, 2024, and is incorporated herein by reference in its entirety.

### FIELD OF THE INVENTION

The present invention relates generally to the field of eyeglasses attachment devices. More specifically, the present invention relates to an ophthalmic device that attaches to eyewear arms to alleviate problems associated with constant eyewear use. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in eyeglasses attachment devices. Generally, people who wear glasses throughout the day may experience heightened eye irritation due to looking through glasses at varied distances. Further, issues like eye strain, reduced nasal flow, unsightly dark marks, etc., can be ailments caused by wearing eyewear for long periods of time. Additionally, deep indentations can occur on the face over time due to eyeglasses being worn.

Furthermore, new glasses, especially can be an issue for some users, based on a new frame shape, size, or weight. New frames can change the pressure points on your face and ears, inciting headaches. A change in your lens type may also cause a dull eye ache behind or around your eyes as you adjust to the prescription strength, channels in the progressive lenses, and a new material coating, etc.

Accordingly, there is a demand for an improved eyeglasses attachment device that attaches to eyewear arms to alleviate problems associated with constant eyewear use. More particularly, there is a demand for an eyeglasses attachment device that features a cradle that holds eyewear arms and offers multifaceted relief from eyewear-related discomfort.

Therefore, there exists a long-felt need in the art for an eyeglasses attachment device that provides users with an ophthalmic device that attaches to eyewear arms to alleviate problems associated with constant eyewear use. There is also a long-felt need in the art for an eyeglasses attachment device that helps reduce eye strain, nasal congestion, and skin indentation caused by constant pressure from eyeglasses. Further, there is a long-felt need in the art for an eyeglasses attachment device that features a cradle that holds eyewear arms. Moreover, there is a long-felt need in the art for a device that utilizes an adjustable positioning mechanism to ensure optimal viewing distance for vision comfort. Further, there is a long-felt need in the art for an eyeglasses attachment device that offers multifaceted relief from eyewear-related discomfort while improving the overall experience for regular eyeglass wearers. Finally, there is a long-felt need in the art for an eyeglasses attachment device that includes a latex coating for comfortable, secure contact with the skin.

The subject matter disclosed and claimed herein, in one embodiment thereof, comprises an eyeglasses attachment device. The device is designed to address common issues associated with prolonged eyewear use, such as eye strain, nasal congestion, and skin indentations caused by constant pressure from glasses. The eyeglasses attachment device comprises an internal gear structure component with a cross member component and a toothed, adjustable central post component featuring a cradle component to hold the arms of the eyewear securely. Further, the device has a latex coating that allows for comfortable, secure contact with the skin, while its adjustable positioning mechanism ensures optimal distance for vision comfort. Additionally, the bottom portion of the device can be moistened so the moist side faces the skin and allows gravity to redefine how the glasses are worn.

In this manner, the eyeglasses attachment device of the present invention affixes to the arms of the eyeglasses and alleviates eye strain by maintaining a steady viewing distance, improving nasal airflow by lifting weight off the nose, and preventing unsightly skin marks through minimized facial contact. This unique, non-surgical solution offers multifaceted relief from eyewear-related discomfort while improving the overall experience for regular eyeglass wearers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an eyeglasses attachment device. The eyeglasses attachment device comprises an internal gear structure component with a cross-member component and a toothed, adjustable central post component featuring a cradle component to hold the arms of the eyewear securely. Further, the device has a latex coating that allows for comfortable, secure contact with the skin, while its adjustable positioning mechanism ensures optimal distance for vision comfort.

In one embodiment, the eyeglasses attachment device is designed to address common issues associated with prolonged eyewear use, such as eye strain, nasal congestion, and skin indentations caused by constant pressure from glasses. By affixing the device to the arms of eyeglasses, users can alleviate eye strain by maintaining a steady viewing distance, can improve nasal airflow by lifting weight off the nose, and can prevent unsightly skin marks by minimizing facial contact. Accordingly, this unique, non-surgical solution offers multifaceted relief from eyewear-related discomfort while improving the overall experience for regular eyeglass wearers.

In one embodiment, the eyeglasses attachment device comprises an internal gear structure component. The internal gear structure component is configured in a round or circular shape with a top, a bottom, and a curved sidewall defining an interior open cavity. Further, the internal circumference of the curved sidewall includes a plurality of gear teeth. The internal gear structure component, specifically the plurality of gear teeth, are responsible for controlling the incline of the eyewear during use. Further, the internal gear structure component is approximately 1″-2″ in diameter, but can be any suitable diameter as is known in the art, depending on the needs and/or wants of a user. Typically, the diameter is as small as can reasonably be made, as it needs to be discreet for use.

In one embodiment, the eyeglasses attachment device comprises a cross-member component. The cross-member component is affixed to the bottom of the internal gear structure component to hold the central post component in place. The cross-member component is configured in a cross or X-shape with a through-hole in the middle of the apex. The through-hole is sized and shaped to accept the central post component during use.

In one embodiment, the eyeglasses attachment device comprises a toothed, adjustable central post component. Specifically, the central post component is approximately 0.5″-1.0″ in length but can be any suitable length as is known in the art. Further, the central post component is sized and shaped to be inserted through the through-hole in the middle of the apex of the cross-member component and secured via a pin connection or other suitable connection that allows the central post component to rotate within the through-hole. Specifically, the central post component includes a bladed tooth component that engages the plurality of gear teeth of the internal gear structure component. Once in place, the central post component can be rotated, allowing the bladed tooth component to engage the plurality of gear teeth, to control the incline of the eyewear during use. This creates an adjustable positioning mechanism that ensures optimal distance for vision comfort of the user.

In one embodiment, the eyeglasses attachment device comprises a housing component. The housing component is shaped and sized to be placed over the internal gear structure component, the cross-member component, and the central post component to protect the integrity of the device. The housing component can be any suitable size and shape as is known in the art, as long as the housing component is sized and shaped to completely cover and protect the internal gear structure component, the cross-member component, and the central post component of the device. Typically, the housing component is conical in shape to cover the assembled device components.

In one embodiment, the eyeglasses attachment device features a cradle component to hold the arms of the eyewear securely. Specifically, the cradle component is configured in a hammock-like or V-shape for accepting an arm of the eyewear. The cradle component comprises an opening for accepting the eyewear arm. Further, the opening of the cradle component is sized and shaped such that the eyewear arm is held firmly within the opening during use. Typically, the cradle component is secured via being screwed to the top of the central post component with the opening facing upward to receive the eyewear arm.

In one embodiment, the eyeglasses attachment device has a latex coating that allows for comfortable, secure contact with the skin. Specifically, the entire device is coated in a latex or silicone-like covering. Typically, the latex coating is wafer thin at the bottom of the device and then more robust toward the top of the device.

In operation, an eyeglasses attachment device is positioned on the arm of an eyeglass, such that the cradle component of the device retains the eyeglass arm firmly within the opening. The device is adjusted to the user via the central post component being rotated, which allows the bladed tooth component to engage the plurality of gear teeth, to control the incline of the eyewear during use. This creates an adjustable positioning mechanism that ensures optimal distance for vision comfort of the user. The housing component is then positioned on a user's skin, such that the device improves nasal airflow by lifting weight off the user's nose and prevents unsightly skin marks through minimized facial contact. Further, in one embodiment, the bottom portion of the housing component can be moistened so the moist side faces the skin and allows gravity to redefine how the eyeglasses are worn.

In one embodiment, the eyeglasses attachment device is manufactured from molded plastic, such as PVC, ABS, polycarbonate, etc., or other suitable materials as is known in the art, or a combination of such materials. Further, the device comprises a latex coating that allows for comfortable, secure contact with the skin. Generally, the eyeglasses attachment device is also manufactured from a material that is water resistant or waterproof, or comprises a coating that is water resistant or waterproof. Also, the device can be manufactured of antibacterial or antimicrobial material or comprises a coating that is antibacterial or antimicrobial. Furthermore, the device can be molded in various colors and patterns to match a user's eyeglasses, based upon a user's preferences.

In yet another embodiment, the eyeglasses attachment device comprises a plurality of indicia.

In yet another embodiment, a method of retaining eyeglass arms such that they lift the weight off a user's nose and ears is disclosed. The method includes the steps of providing an eyeglasses attachment device comprising an internal gear structure component, a cross-member component, and a central post component secured together in a housing component with a cradle component. The method also comprises securing the cradle component to the arms of the eyewear. Further, the method comprises adhering the housing component to the user's skin. The method also comprises adjusting the internal gear structure component and the central post component to ensure optimal distance for vision comfort. Finally, the method comprises providing a latex coating of the device for a comfortable, secure contact with the user's skin.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the eyeglasses attachment device of the present invention showing the internal gear structure component in accordance with the disclosed architecture;

FIG. 2 illustrates a perspective view of one embodiment of the eyeglasses attachment device of the present invention showing the cross-member component in accordance with the disclosed architecture;

FIG. 3 illustrates a perspective view of one embodiment of the eyeglasses attachment device of the present invention showing the central post component in accordance with the disclosed architecture;

FIG. 4 illustrates a perspective view of one embodiment of the eyeglasses attachment device of the present invention showing the housing component in accordance with the disclosed architecture;

FIG. 5 illustrates a perspective view of one embodiment of the eyeglasses attachment device of the present invention showing the cradle component in accordance with the disclosed architecture;

FIG. 6 illustrates a perspective view of one embodiment of the eyeglasses attachment device of the present invention showing the device in use in accordance with the disclosed architecture; and

FIG. 7 illustrates a flowchart showing the method of retaining eyeglass arms such that they lift the weight off a user's nose and ears in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an eyeglasses attachment device that provides users with an ophthalmic device that attaches to eyewear arms to alleviate problems associated with constant eyewear use. There is also a long-felt need in the art for an eyeglasses attachment device that helps reduce eye strain, nasal congestion, and skin indentation caused by constant pressure from eyeglasses. Further, there is a long-felt need in the art for an eyeglasses attachment device that features a cradle that holds eyewear arms. Moreover, there is a long-felt need in the art for a device that utilizes an adjustable positioning mechanism to ensure optimal viewing distance for vision comfort. Further, there is a long-felt need in the art for an eyeglasses attachment device that offers multifaceted relief from eyewear-related discomfort while improving the overall experience for regular eyeglass wearers. Finally, there is a long-felt need in the art for an eyeglasses attachment device that includes a latex coating for comfortable, secure contact with the skin.

The present invention, in one exemplary embodiment, is a novel eyeglasses attachment device. The eyeglasses attachment device comprises an internal gear structure component with a cross-member component and a toothed, adjustable central post component featuring a cradle component to hold the arms of the eyewear securely. Further, the device has a latex coating that allows for comfortable, secure contact with the skin, while its adjustable positioning mechanism ensures optimal distance for vision comfort. The present invention also includes a novel method of retaining eyeglass arms such that they lift the weight off a user's nose and ears. The method includes the steps of providing an eyeglasses attachment device comprising an internal gear structure component, a cross-member component, and a central post component secured together in a housing component with a cradle component. The method also comprises securing the cradle component to the arms of the eyewear. Further, the method comprises adhering the housing component to the user's skin. The method also comprises adjusting the internal gear structure component and the central post component to ensure optimal distance for vision comfort. Finally, the method comprises providing a latex coating of the device for a comfortable, secure contact with the user's skin.

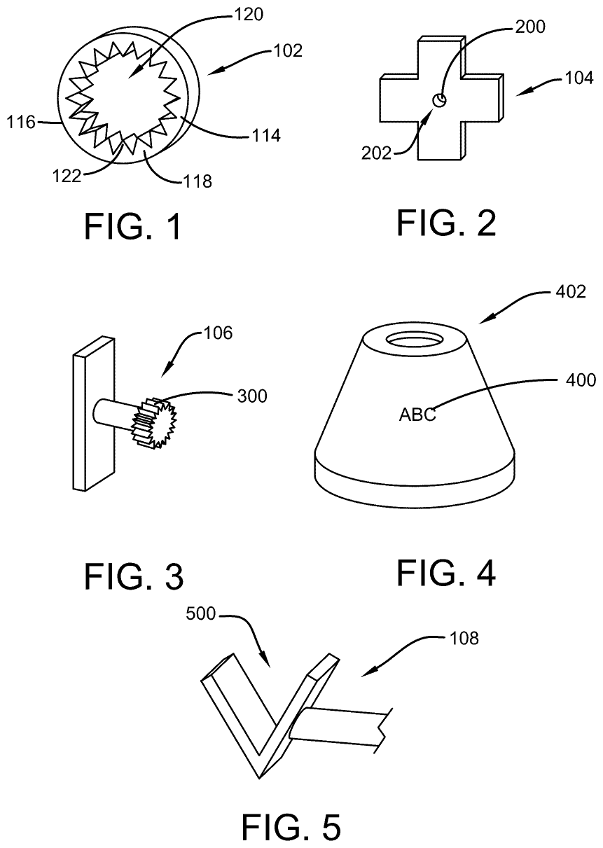

Referring initially to the drawings, FIGS. 1-6 illustrate a perspective view of one embodiment of the eyeglasses attachment device 100 of the present invention. In the present embodiment, the eyeglasses attachment device 100 is an improved eyeglasses attachment device 100 that is designed to address common issues associated with prolonged eyewear use. Specifically, the eyeglasses attachment device 100 comprises an internal gear structure component 102, a cross-member component 104, and a central post component 106 secured together. A cradle component 108 is then secured to the central post component 106 to hold the arms 110 of the eyewear 112 securely off of a user's skin.

Generally, the eyeglasses attachment device 100 is designed to address common issues associated with prolonged eyewear use, such as eye strain, nasal congestion, and skin indentations caused by constant pressure from glasses 112. By affixing the device 100 to the arms 110 of eyeglasses 112, users can alleviate eye strain by maintaining a steady viewing distance, can improve nasal airflow by lifting weight off the nose, and can prevent unsightly skin marks by minimizing facial contact. Accordingly, this unique, non-surgical solution offers multifaceted relief from eyewear-related discomfort while improving the overall experience for regular eyeglass wearers.

As shown in FIG. 1, the eyeglasses attachment device 100 comprises an internal gear structure component 102. The internal gear structure component 102 is configured in a round or circular shape with a top 114, a bottom 116, and a curved sidewall 118 defining an interior open cavity 120. Further, the internal circumference of the curved sidewall 118 includes a plurality of gear teeth 122. The internal gear structure component 102, specifically the plurality of gear teeth 122, are responsible for controlling the incline of the eyewear 112 during use. Further, the internal gear structure component 102 is approximately 1″-2″ in diameter, but can be any suitable diameter as is known in the art, depending on the needs and/or wants of a user. Typically, the diameter is as small as can reasonably be made, as it needs to be discreet for use.

As shown in FIG. 2, the eyeglasses attachment device 100 comprises a cross-member component 104. The cross-member component 104 is affixed to the bottom 116 of the internal gear structure component 102 to hold the central post component 106 in place. The cross-member component 104 is configured in a cross or X-shape with a through-hole 200 in the middle of the apex 202. The through-hole 200 is sized and shaped to accept the central post component 106 during use.

As shown in FIG. 3, the eyeglasses attachment device 100 comprises a toothed, adjustable central post component 106. Specifically, the central post component 106 is approximately 0.5″-1.0″ in length, but can be any suitable length as is known in the art. Further, the central post component 106 is sized and shaped to be inserted through the through-hole 200 in the middle of the apex 202 of the cross-member component 104 and secured via a pin connection or other suitable connection that allows the central post component 106 to rotate within the through-hole 200. Specifically, the central post component 106 includes a bladed tooth component 300 that engages the plurality of gear teeth 122 of the internal gear structure component 102. Once in place, the central post component 106 can be rotated, allowing the bladed tooth component 300 to engage the plurality of gear teeth 122, to control the incline of the eyewear 112 during use. This creates an adjustable positioning mechanism that ensures optimal distance for vision comfort of the user.

As shown in FIG. 4, the eyeglasses attachment device 100 comprises a housing component 402. The housing component 402 is shaped and sized to be placed over the internal gear structure component 102, the cross-member component 104, and the central post component 106 to protect the integrity of the device 100. The housing component 402 can be any suitable size and shape as is known in the art, as long as the housing component 402 is sized and shaped to completely cover and protect the internal gear structure component 102, the cross-member component 104, and the central post component 106 of the device 100. Typically, the housing component 402 is conical in shape to cover the assembled device components.

In yet another embodiment, the eyeglasses attachment device 100 comprises a plurality of indicia 400. The housing component 402 of the device 100 may include advertising, a trademark, or other letters, designs, or characters, printed, painted, stamped, or integrated into the housing component 402, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be eyeglasses, eyeglass arm, or brand related.

As shown in FIG. 5, the eyeglasses attachment device 100 features a cradle component 108 to hold the arms 110 of the eyewear 112 securely. Specifically, the cradle component 108 is configured in a hammock-like or V-shape for accepting an arm 110 of the eyewear 112. The cradle component 108 comprises an opening 500 for accepting the eyewear arm 110. Further, the opening 500 of the cradle component 108 is sized and shaped such that the eyewear arm 110 is held firmly within the opening 500 during use. Typically, the cradle component 108 is secured via being screwed to the top of the central post component 106 with the opening 500 facing upward to receive the eyewear arm 110.

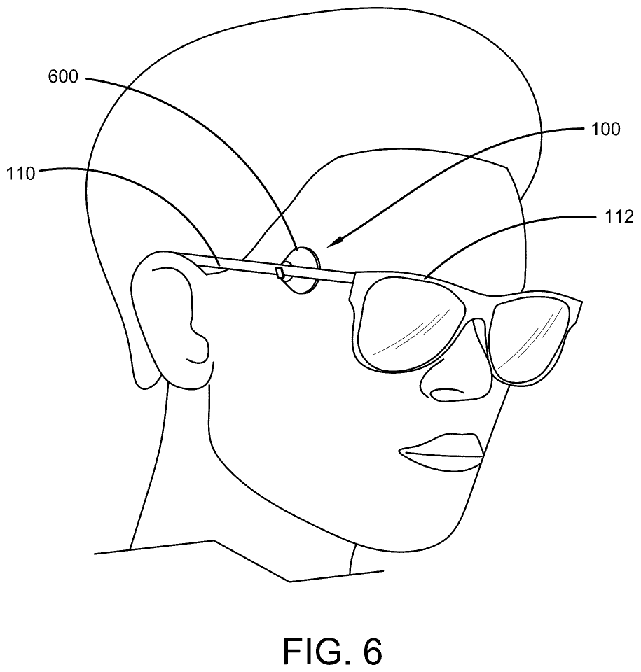

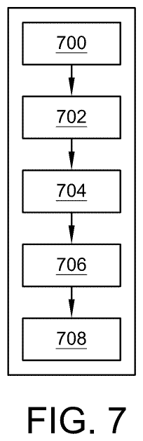

As shown in FIG. 6, the eyeglasses attachment device 100 has a latex coating 600 that allows for comfortable, secure contact with the skin. Specifically, the entire device 100 is coated in a latex or silicone-like covering 600. Typically, the latex coating 600 is wafer thin at the bottom of the device 100 and then more robust toward the top of the device 100.

In operation, an eyeglasses attachment device 100 is positioned on the arm 110 of an eyeglass 112, such that the cradle component 108 of the device 100 retains the eyeglass arm 110 firmly within the opening 500. The device 100 is adjusted to the user via the central post component 106 being rotated, which allows the bladed tooth component 300 to engage the plurality of gear teeth 122, to control the incline of the eyewear 112 during use. This creates an adjustable positioning mechanism that ensures optimal distance for vision comfort of the user. The housing component 402 is then positioned on a user's skin, such that the device 100 improves nasal airflow by lifting weight off the user's nose and prevents unsightly skin marks through minimized facial contact. Further, in one embodiment, the bottom portion of the housing component 402 can be moistened so the moist side faces the skin and allows gravity to redefine how the eyeglasses 112 are worn.

In one embodiment, the eyeglasses attachment device 100 is manufactured from molded plastic, such as PVC, ABS, polycarbonate, etc., or other suitable materials as is known in the art, or a combination of such materials. Further, the device 100 comprises a latex coating 600 that allows for comfortable, secure contact with the skin. Generally, the eyeglasses attachment device 100 is also manufactured from a material that is water resistant or waterproof, or comprises a coating that is water resistant or waterproof. Also, the device 100 can be manufactured of antibacterial or antimicrobial material or comprises a coating that is antibacterial or antimicrobial. Furthermore, the device 100 can be molded in various colors and patterns to match a user's eyeglasses 112, based upon a user's preferences.

FIG. 7 illustrates a flowchart of the method of retaining eyeglass arms such that they lift the weight off a user's nose and ears. The method includes the steps of at 700, providing an eyeglasses attachment device comprising an internal gear structure component, a cross-member component, and a central post component secured together in a housing component with a cradle component. The method also comprises at 702, securing the cradle component to the arms of the eyewear. Further, the method comprises at 704 adhering the housing component to the user's skin. The method also comprises at 706, adjusting the internal gear structure component and the central post component to ensure optimal distance for vision comfort. Finally, the method comprises at 708, providing a latex coating of the device for a comfortable, secure contact with the user's skin.

Certain terms are used throughout the following description and claims to refer to particular features or components. As one skilled in the art will appreciate, different users may refer to the same feature or component by different names. This document does not intend to distinguish between components or features that differ in name but not structure or function. As used herein, “eyeglasses attachment device”, “eyeglasses device”, “attachment device”, and “device” are interchangeable and refer to the eyeglasses attachment device 100 of the present invention.

Notwithstanding the foregoing, the eyeglasses attachment device 100 of the present invention can be of any suitable size and configuration as is known in the art without affecting the overall concept of the invention, provided that it accomplishes the above-stated objectives. One of ordinary skill in the art will appreciate that the eyeglasses attachment device 100, as shown in FIGS. 1-7 is for illustrative purposes only, and that many other sizes and shapes of the eyeglasses attachment device 100 are well within the scope of the present disclosure. Although the dimensions of the eyeglasses attachment device 100 are important design parameters for user convenience, the eyeglasses attachment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An eyeglasses attachment device that alleviates constant eyewear problems, the eyeglasses attachment device comprising:
an internal gear structure component;
a cross-member component; and
a central post component;
wherein the cross-member component is positioned under the internal gear structure component;
wherein the central post component is used to secure the cross-member component and the internal gear structure component together for use; and
further wherein a cradle component is secured to the central post component to hold an eyeglass arm securely off of a user's skin.

2. The eyeglasses attachment device of claim 1, wherein the internal gear structure component is configured in a round or circular shape with a top, a bottom and a curved sidewall defining an interior open cavity.

3. The eyeglasses attachment device of claim 2, wherein an internal circumference of the curved sidewall includes a plurality of gear teeth.

4. The eyeglasses attachment device of claim 3, wherein the internal gear structure component is approximately 1″-2″ in diameter.

5. The eyeglasses attachment device of claim 4, wherein the cross-member component is configured in a cross or X-shape with a through-hole in a middle of an apex.

6. The eyeglasses attachment device of claim 5, wherein the through-hole is sized and shaped to accept the central post component during use.

7. The eyeglasses attachment device of claim 6, wherein the central post component is approximately 0.5″-1.0″ in length.

8. The eyeglasses attachment device of claim 7, wherein the central post component is sized and shaped to be inserted through the through-hole in the middle of the apex of the cross-member component and secured via a pin connection to allow the central post component to rotate within the through-hole.

9. The eyeglasses attachment device of claim 8, wherein the central post component includes a bladed tooth component that engages the plurality of gear teeth of the internal gear structure component, to control incline of the eyeglasses during use.

10. The eyeglasses attachment device of claim 9, wherein a housing component is shaped and sized to be placed over the internal gear structure component, the cross-member component, and the central post component to protect integrity of the eyeglasses attachment device.

11. The eyeglasses attachment device of claim 10 further comprising a plurality of indicia.

12. The eyeglasses attachment device of claim 11, wherein the cradle component is configured in a hammock-like or V-shape for accepting the eyeglass arm.

13. The eyeglasses attachment device of claim 12, wherein the cradle component comprises an opening for accepting the eyewear arm and the opening is sized and shaped to firmly retain the eyewear arm within the opening during use.

14. The eyeglasses attachment device of claim 13, wherein the eyeglasses attachment device has a latex coating that allows for comfortable, secure contact with a user's skin.

15. An eyeglasses attachment device that alleviates constant eyewear problems, the eyeglasses attachment device comprising:
an internal gear structure component configured in a round or circular shape with a top, a bottom and a curved sidewall defining an interior open cavity lined with a plurality of gear teeth;
a cross-member component configured in a cross or X-shape with a through-hole in a middle of an apex; and
a central post component sized and shaped to be inserted through the through-hole in the middle of the apex of the cross-member component and secured via a pin connection to allow the central post component to rotate within the through-hole; and
wherein the cross-member component is positioned under the internal gear structure component;
wherein the central post component is used to secure the cross-member component and the internal gear structure component together for use;
wherein the central post component includes a bladed tooth component that engages the plurality of gear teeth of the internal gear structure component, to control incline of the eyeglasses during use;
wherein a housing component is shaped and sized to be placed over the internal gear structure component, the cross-member component, and the central post component to protect integrity of the eyeglasses attachment device;
wherein a cradle component is secured to the central post component to hold an eyeglass arm securely off of a user's skin;
wherein the cradle component comprises an opening for accepting the eyewear arm and the opening is sized and shaped to firmly retain the eyewear arm within the opening during use; and
further wherein the eyeglasses attachment device has a latex coating that allows for comfortable, secure contact with a user's skin.

16. The eyeglasses attachment device of claim 15, wherein the latex coating is wafer thin at a bottom and then more robust toward a top of the eyeglasses attachment device.

17. The eyeglasses attachment device of claim 15, wherein a bottom portion of the housing component can be moistened so moist side faces a user's skin and allows gravity to redefine how the eyeglasses are worn.

18. The eyeglasses attachment device of claim 15, wherein the eyeglasses attachment device comprises a coating that is water resistant or waterproof and comprises a coating that is antibacterial or antimicrobial.

19. The eyeglasses attachment device of claim 15, wherein the eyeglasses attachment device is molded in various colors and patterns to match a user's eyeglasses.

20. A method of retaining eyeglass arms such that they lift the weight off a user's nose and ears, the method comprising the following steps:
providing an eyeglasses attachment device comprising an internal gear structure component, a cross-member component, and a central post component secured together in a housing component with a cradle component;
securing the cradle component to the arms of the eyewear;
adhering the housing component to the user's skin;
adjusting the internal gear structure component and the central post component to ensure optimal distance for vision comfort; and
providing a latex coating of the device for a comfortable, secure contact with the user's skin.
